(19) United States
(12) Patent Application Publication
(10) Pub. No.: US 2005/0286163 A1
(43) Pub. Date: Dec. 29, 2005

(54) Hard disk drive with damping plate

(75) Inventors: Youn-tai Kim, Gyeonggi-do (KR); Sung-wook Kim, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/151,245

(22) Filed: Jun. 14, 2005

(30) Foreign Application Priority Data
Jun. 24, 2004 (KR) 10-2004-0047622

(51) Int. Cl. G11B 33/14

(52) U.S. Cl. 360/97.02

(57) ABSTRACT

A hard disk drive with a housing including a base member supporting a spindle motor rotating a data storage disk and an actuator having a read/write head, a cover member coupled to the base member to encompass the spindle motor and the actuator, a damping plate spaced a predetermined distance from an upper surface of the cover member to form an air gap between the damping plate and the cover member, a buffer member arranged between an edge portion of the cover member and an edge portion of the damping plate, and an air channel between the cover member and the damping plate to connect the air gap with the outside.

### CROSS-REFERENCE TO RELATED APPLICATIONS

This application claims the benefit of Korean Patent Application No. 10-2004-0047622, filed on Jun. 24, 2004, in the Korean Intellectual Property Office, the disclosure of which is incorporated herein in its entirety by reference.

### BACKGROUND OF THE INVENTION

1. Field of the Invention

Embodiments of the present invention relate to hard disk drives, and more particularly, to a method and hard disk drive preventing a damping plate from absorbing an external impact and limiting internal noise transmission generated from the damping plate being pressed too closely to a hard disk drive cover member.

2. Description of the Related Art

A hard disk drive (HDD), which is one of the data storage devices used in computers, reproduces data stored on a disk or records data onto the disk using a read/write head. In the HDD, to perform the above functions, the head is moved to a desired position by an actuator, by being lifted a predetermined height above a recording surface of a rotating disk.

FIG. 1 is an exploded perspective view illustrating an example of a conventional HDD, with FIG. 2 illustrating a vertical sectional view of the housing of FIG. 1.

Referring to FIGS. 1 and 2, the conventional HDD includes a housing 10 having a base member 11 and a cover member 12, a spindle motor 30 installed on the base member 11, one or a plurality of data storage disks 20 installed on the spindle motor 30, and an actuator 40 to move a read/write head for reproducing and recording data to a predetermined position on the disk 20.

The actuator 40 includes a swing arm 44 rotatably coupled to a pivot 42 installed on the base member 11, a suspension 46 installed an end portion of the swing arm 44 to support a slider 48 where the head is mounted elastically biased toward a surface of the disk 20, and a voice coil motor (VCM) 50 to rotate the swing arm 44. The VCM 50 is controlled by a servo control system to rotate the swing arm 44, in a direction following Fleming's left hand rule, by interaction between current applied to a corresponding VCM coil and magnetic field formed by a magnet. That is, when the power of the HDD is on and the disk 20 starts to rotate, the VCM 50 rotates the swing arm 44 to move the slider 48 such that the head is mounted above a recording surface of the disk 20. In contrast, when the power of the HDD is off and the disk 20 stops rotation, the VCM 50 rotates the swing arm 44 to move the head away from the recording surface of the disk 20.

The cover member 12 can be attached to an upper portion of the base member 11 using a plurality of coupling screws 19, for example. A gasket 13 can be inserted between the base member 11 and the cover member 12 to prevent intrusion of dust or moisture into the HDD. The gasket 13 is typically made of a visco-elastic material, for example, rubber, and may further attenuate vibrations of the HDD.

A screw insertion hole 17, in which a pivot fixing screw 18 couples to a pivot 42 of the actuator 40, is formed in the cover member 12. The cover member 12 is typically a diecast aluminum alloy.

The housing 10 of the HDD is generally structured to absorb external impacts and buffer internal noise. In detail, a damping plate 15, which may be thin and made of stainless steel, can be installed on an upper surface of the cover member 12. The damping plate 15 is thereby spaced a predetermined distance from the upper surface of the cover member 12 by a buffer member 14. Accordingly, an air gap 16 can be formed between the damping plate 15 and the cover member 12. The air gap 16 reduces noise inside the HDD and works as an air damper to absorb impact energy applied to the damping plate 15. The buffer member 14 reduces the impact energy transferred from the damping plate 15 to the cover member 12 and can be formed of a visco-elastic material, for example, nitrile butadiene rubber (NBR).

The HDD, configured as above, typically undergoes a cleaning operation during an assembly process. After the cleaning operation, the HDD may undergo a drying operation in a vacuum state, to improve a drying efficiency. In the vacuum drying operation, air inside the air gap 16 escapes due to the large difference in pressure within air gap 16 and outside of the air gap 16, such that the damping plate 15 may be pressed toward the cover member 12, and even potentially contact the upper surface of the cover member 12. After the drying operation is complete, it takes a long time to refill the air gap 16 with air and reverse the pressure differential.

The assembled HDD also undergoes an altitude test. Since the altitude test is performed with various pressure conditions, as the air inside the air gap 16 is exhausted, because of the differences in pressure, the damping plate 15 may again be pressed into contact with the cover member 12.

However, when the damping plate 15 becomes bent, due to the differences in pressure, and contacts the cover member 12, what is left of the air gap 16 does not properly perform absorption of the impact energy applied to the damping plate 15, and the impact energy is actually directly transferred to the cover member 12. Also, noise inside the HDD is not properly absorbed by the air gap 16, resulting in noise being transferred to the outside.

### SUMMARY OF THE INVENTION

To solve the above and/or other problems, embodiments of the present invention provide a hard disk drive, and hard disk drive housing, having a structure preventing the close contact of the damping plate and the cover member of the hard disk drive housing, thereby maintaining performance of an air gap between the damping plate and the cover member, absorbing external impacts and internal noise.

To achieve the above and/or other aspects and advantages, embodiments of the present invention set forth a housing for a hard disk drive, including a base member for supporting a spindle motor rotating a data storage disk and an actuator having a read/write head, a cover member coupled to the base member to encompass the spindle motor and the actuator, a damping plate separated a predetermined distance from an upper surface of the cover member forming an air gap between the damping plate and the cover member, a buffer member arranged between an edge portion of the cover member and an edge portion of the damping plate to seal the air gap, and an air channel to connect the sealed air gap, at an inside of at least one area of the cover member, the buffer member, and the damping plate, with an outside of at least one area of the cover member, the buffer member, and the damping plate.

The air channel may be formed along an edge portion of the upper surface of the cover member. Further, the air channel may be formed in the cover member during diecasting of the cover member.

The air channel may be formed along an edge portion of a lower surface of the damping plate. The air channel may be formed in the damping plate during press processing of the damping plate.

In addition, the air channel may restrict passage of moisture and foreign materials while passing air. The air channel may also have a zigzag form, and both of a depth and a width of the air channel may be less than 1 mm.

To achieve the above and/or other aspects and advantages, embodiments of the present invention set forth a hard disk drive, including a spindle motor rotating a data storage disk, an actuator having a read/write head, a base member supporting the spindle motor and the actuator, a cover member coupled to the base member to encompass the spindle motor and the actuator, a damping plate separated a predetermined distance from an upper surface of the cover member forming an air gap between the damping plate and the cover member, a buffer member arranged between an edge portion of the cover member and an edge portion of the damping plate to seal the air gap, and an air channel to connect the sealed air gap, at an inside of at least one area of the cover member, buffer member, and the damping plate, with an outside of at least one area of the cover member, buffer member, and the damping plate.

To achieve the above and/or other aspects and advantages, embodiments of the present invention set forth a housing protection method for a hard disk drive, including forming an air gap between a damping plate, supporting a spindle motor rotating a data storage disk and an actuator having a read/write head with a base member, and a cover member, encompassing the spindle motor and the actuator with a cover member coupled to the base member, with the damping plate separated a predetermined distance from an upper surface of the cover member, sealing the air gap, and connecting the sealed air gap, at an inside of at least one area near the cover member and the damping plate, with an outside of at least one area near the cover member and the damping plate, through an air channel.

The connecting of the air-gap may further include equalizing pressure between the air-gap and a pressure outside the air gap.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view of an exemplary conventional hard disk drive;

FIG. 2 is a vertical sectional view illustrating a portion of the conventional housing of FIG. 1;

FIG. 3 is an exploded perspective view of a hard disk drive, according to an embodiment of the present invention;

FIG. 4 is a vertical sectional view illustrating a portion of a hard disk drive, of FIG. 3, for example, according to an embodiment of the present invention; and

FIG. 5 is a vertical sectional view illustrating a portion of a hard disk drive, according to another embodiment of the present invention.

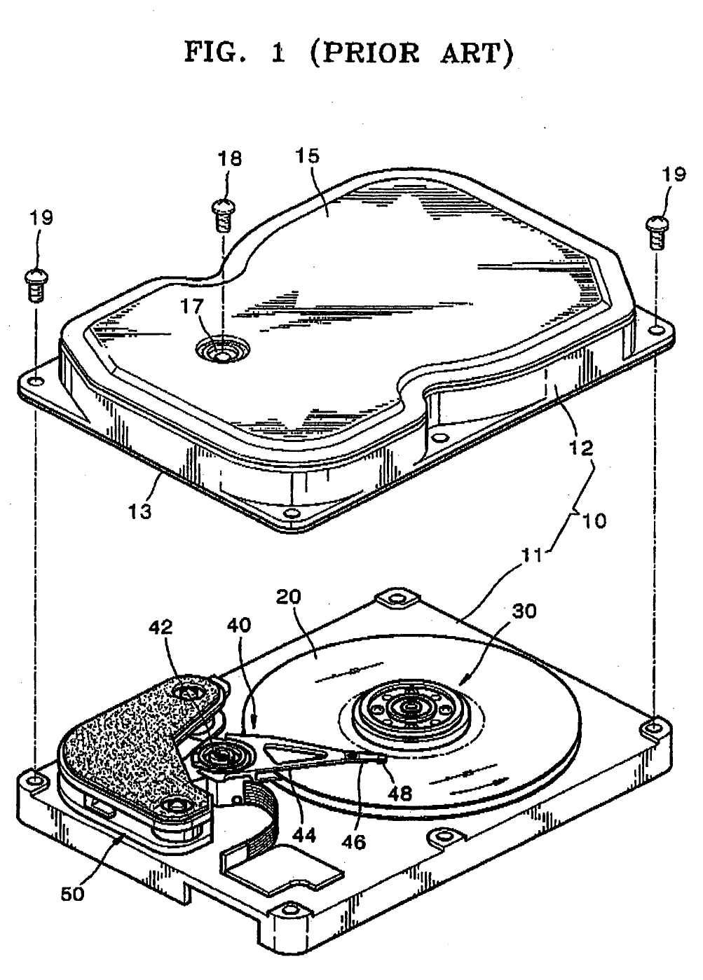

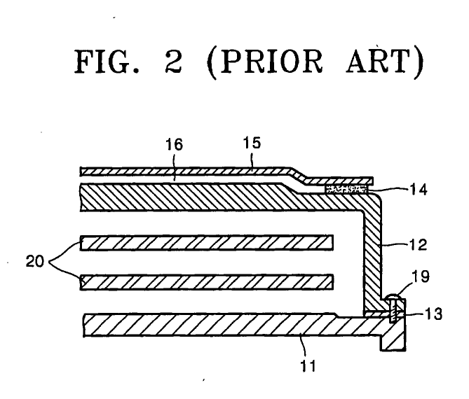

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

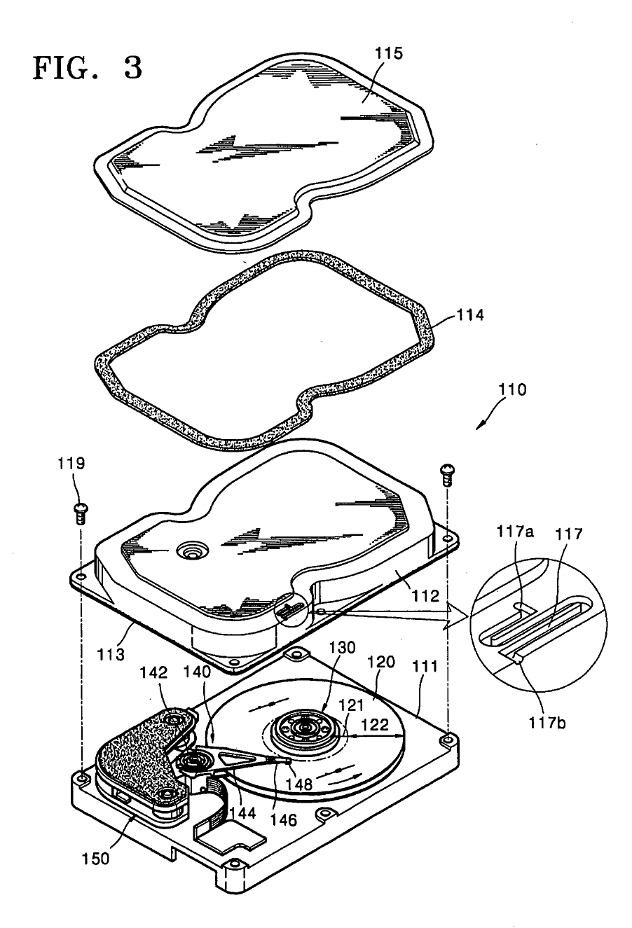

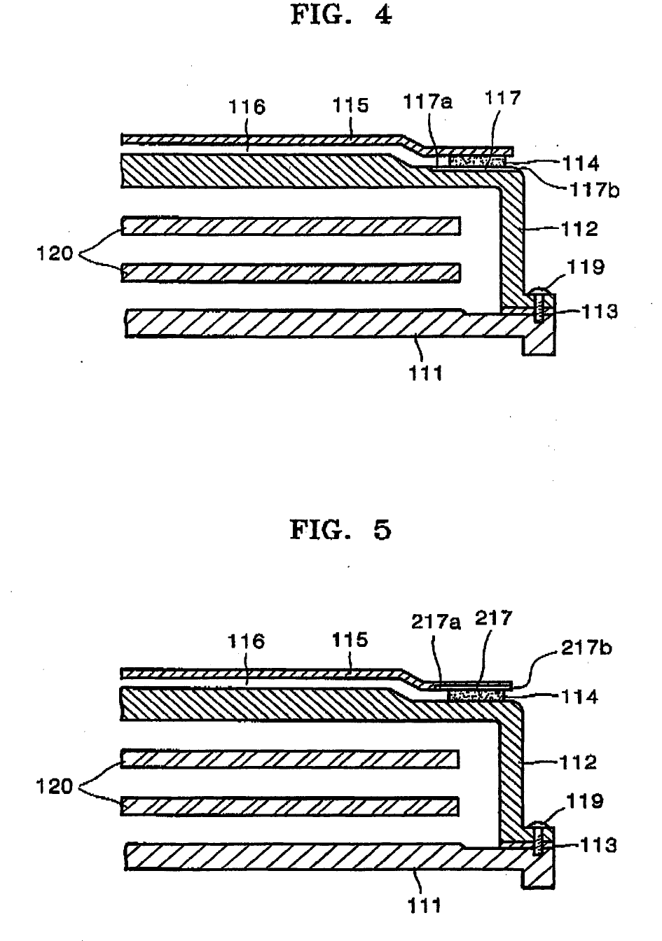

Referring to FIGS. 3 and 4, a hard disk drive having a housing, according to an embodiment of the present invention, may include a disk 120 for storing data, a spindle motor 130 for rotating the disk 120, and an actuator 140 for moving a read/write head to a predetermined position over the disk 120. The disk 120, the spindle motor 130, and the actuator 140 can be encompassed and protected by a housing 110.

The disk 120 may be a recording medium recording data, with one or a more disks being installed on the spindle motor 130 and rotated by the spindle motor 130. A parking zone 121, where the head is parked when the hard disk drive stops operation, and a data zone 122, where data is recorded, can be provided at inner and outer circumferential areas of the disk 120, respectively.

The actuator 140 can be installed on a base member 111 of the housing 110 and may be capable of pivoting and moving the head to a predetermined position on the disk 120 to record data on the disk 120 or reproduce recorded data from the disk 120. In detail, the actuator 140 can include a swing arm 144, rotatably coupled to a pivot 142 installed on the base member 111, a suspension 146, installed an end portion of the swing arm 144 to support a slider 148 where the head may be mounted elastically biased toward a surface of the disk 120, and a voice coil motor (VCM) 150 to rotate the swing arm 144.

The VCM 150 can be controlled by a servo control system and rotate the swing arm 144 in a direction following the Fleming's left hand rule by interaction between current applied to a VCM coil and a magnetic field formed by a magnet. That is, when the power of the hard disk drive is on, and the disk 120 starts to rotate, the VCM 150 rotates the swing arm 144 to move the slider 148 from the parking zone 121 to the data zone 122. The slider 148 is thus lifted to a predetermined height above the surface of the disk 120 by a lift force generated by the rotating disk 120. In this state, the head mounted on the slider 148 can performs functions of reproducing/recording data from/to the disk 120. In contrast, when the power of the hard disk drive is off, and the disk 120 stops rotation, the VCM 150 rotates the swing arm 144 counterclockwise so that the slider 148 is parked in the parking zone 121 of the disk 120.

In the head parking system, there may be a ramp loading method, in addition to the above-described contact start stop (CSS) method. In a ramp loading type head parking system, a ramp (not shown) is installed outside the disk 120 areas, parked on the ramp. Embodiments of the present invention may be applied to not only to hard disk drives having the CSS type head parking system, but also to hard disk drives having ramp loading type head parking systems.

The housing 110 includes the base member 111, supporting the disk 120, the spindle motor 130, and the actuator 140, and a cover member 112, which is illustrated as being attached to the base member 111 and encompassing and protecting the disk 120, the spindle motor 130, and the actuator 140. Here, the cover member 112 is coupled to the base member 111 using a plurality of coupling screws 119, for example. A gasket 113 is also inserted between the base member 111 and the cover member 112 to prevent intrusion of dust or moisture into the hard disk drive. The gasket 113 may typically be made of a visco-elastic material, for example, rubber, and function to attenuate vibrations of the hard disk drive.

The housing 110, according to embodiments of the present embodiment, may further include a damping plate 115 arranged above the cover member 112, and a buffer member 114 and an air channel 117 provided between the damping plate 115 and the cover member 112.

The damping plate 115 can be made of a metal plate exhibiting elasticity. For example, the damping plate 115 can be manufactured by pressing a stainless steel plate having a thickness of not more than 1 mm to have a shape corresponding to a shape of an upper surface of the cover member 112. The damping plate 115 can thereby be spaced a predetermined distance from the upper surface of the cover member 112. Thus, an air gap 116 can be formed between the damping plate 115 and the cover member 112. Based on embodiments of the present invention, the air gap 116 absorbs noise generated inside the hard disk drive and simultaneously works as an air damper for absorbing impact energy applied to the damping plate 115.

The buffer member 114 can be arranged between an edge portion of the cover member 112 and an edge portion of the damping plate 115. Here, the buffer member 114 has a shape encompassing the air gap 116, formed between the damping plate 115 and the cover member 112. The upper and lower surfaces of the buffer member 114 can be attached to the lower surface of the damping plate 115 and the upper surface of the cover member 112, respectively, by using a predetermined adhesive, for example.

The buffer member 114 absorbs and reduces the impact energy transferred from the damping plate 115 to the cover member 112. For this purpose, the buffer member 114 can be made of a visco-elastic material such as rubber or polymer.

The air channel 117, which is a feature of embodiments of the present invention, can be provided between the cover member 112 and the damping plate 115, and connects the air gap 116 to the outside to constantly maintain pressure inside the air gap 116 with the pressure outside the air gap 116.

The air channel 117 can be formed at an edge portion of the upper surface of the cover member 112 and have a predetermined depth, as an example. The air channel 117 can be formed using various methods. For example, as the cover member 112 is typically manufactured by diecasting, using an aluminum alloy, the air channel 117 could be integrally formed when the cover member 112 is manufactured. The air channel 117 can also be formed by mechanically cutting the upper surface of the cover member 112, for example.

The air channel 117 can be formed to restrict passage of moisture and foreign materials while passing air to equalize pressures. For this purpose, in embodiments of the present invention, the air channel 117 shown in FIG. 3 is formed in a zigzag form in order to have the greatest length possible. The air channel 117 can be formed along a position which can be covered by the buffer member 114 so that an end 117a of the air channel 117 is connected to the air gap 116 and the other end 117b is connected to the outside, e.g., the outside of the housing 110.

The air channel 117 can be formed to have a depth and width as small as possible, e.g., to restrict the intrusion of moisture and foreign materials into the air gap 116. In an embodiment, the depth and width of the air channel 117 are formed to be less than 1 mm, for example, 0.6 mm deep and 0.8 mm wide.

According to the embodiment of the present invention, configured as above, in a vacuum drying process or an altitude test process of the hard disk drive, the pressure inside and outside of the air gap 116 can constantly be equalized by the air channel 117. Thus, contrary to the conventional problem of the damping plate being caused to be pressed to contact the cover member, in embodiments of the present invention the external impact and internal noise absorption performance of the air gap 116, formed between the damping plate 115 and the cover member 112, is maintained.

FIG. 5 is a vertical sectional view illustrating a portion of a disk drive, according to another embodiment of the present invention. Referring to FIG. 5, an air channel 217 can be utilized to connect the air gap 116 with the outside, with the air channel 217 being formed in the damping plate 115. The air channel 217 can be formed along an edge portion of the lower surface of the damping plate 115, such that the two ends 217a and 217b of the air channel 217 connect the air gap 116 to the outside. In an embodiment of the present invention, the air channel 217 can be formed together in a press processing operation of a metal plate, for example, a stainless steel plate, to manufacture the damping plate 115.

The air channel 217 may be formed with the zigzag form, as shown in FIG. 3, to restrict the intrusion of moisture and foreign materials into the air gap 116. The length and width of the air channel 217 may be formed as small as possible.

When the air channel 217 is formed in the lower surface of the damping plate 115, not in the upper surface of the cover member 112, the similar benefits described in the previous embodiment are obtained.

As described above, according to embodiments of the present invention, since the pressure inside and outside the air gap can be equalized by an air channel, even when an external pressure condition changes, the damping plate can be prevented from being forced to press closely with the cover member. Thus, external impact and internal noise absorption performance of an air gap formed between the damping plate and the cover member can be maintained.

Although a few embodiments of the present invention have been shown and described, it would be appreciated by those skilled in the art that changes may be made in these embodiments without departing from the principles and spirit of the invention, the scope of which is defined in the claims and their equivalents.

1. A housing for a hard disk drive, comprising:
a base member for supporting a spindle motor rotating a data storage disk and an actuator having a read/write head;
a cover member coupled to the base member to encompass the spindle motor and the actuator;
a damping plate separated a predetermined distance from an upper surface of the cover member forming an air gap between the damping plate and the cover member;
a buffer member arranged between an edge portion of the cover member and an edge portion of the damping plate to seal the air gap; and
an air channel to connect the sealed air gap, at an inside of at least one area of the cover member, the buffer member, and the damping plate, with an outside of at least one area of the cover member, the buffer member, and the damping plate.

2. The housing of claim 1, wherein the air channel is formed along an edge portion of the upper surface of the cover member.

3. The housing of claim 2, wherein the air channel is formed in the cover member during diecasting of the cover member.

4. The housing of claim 1, wherein the air channel is formed along an edge portion of a lower surface of the damping plate.

5. The housing of claim 4, wherein the air channel is formed in the damping plate during press processing of the damping plate.

6. The housing of claim 1, wherein the air channel restricts passage of moisture and foreign materials while passing air.

7. The housing of claim 6, wherein the air channel has a zigzag form.

8. The housing of claim 6, wherein both of a depth and a width of the air channel is less than 1 mm.

9. A hard disk drive, comprising:
a spindle motor rotating a data storage disk;
an actuator having a read/write head;
a base member supporting the spindle motor and the actuator;
a cover member coupled to the base member to encompass the spindle motor and the actuator;
a damping plate separated a predetermined distance from an upper surface of the cover member forming an air gap between the damping plate and the cover member;
a buffer member arranged between an edge portion of the cover member and an edge portion of the damping plate to seal the air gap; and
an air channel to connect the sealed air gap, at an inside of at least one area of the cover member, buffer member, and the damping plate, with an outside of at least one area of the cover member, buffer member, and the damping plate.

10. The hard disk drive of claim 9, wherein the air channel is formed along an edge portion of the upper surface of the cover member.

11. The hard disk drive of claim 9, wherein the air channel is formed along an edge portion of a lower surface of the damping plate.

12. The hard disk drive of claim 9, wherein the air channel restricts passage of moisture and foreign materials while passing air.

13. The hard disk drive of claim 9, wherein the air channel has a zigzag form.

14. The hard disk drive of claim 9, wherein both of a depth and a width of the air channel is less than 1 mm.

15. A housing protection method for a hard disk drive, comprising:
forming an air gap between a damping plate, supporting a spindle motor rotating a data storage disk and an actuator having a read/write head with a base member, and a cover member, encompassing the spindle motor and the actuator with a cover member coupled to the base member, with the damping plate separated a predetermined distance from an upper surface of the cover member;
sealing the air gap; and
connecting the sealed air gap, at an inside of at least one area near the cover member and the damping plate, with an outside of at least one area near the cover member and the damping plate, through an air channel.

16. The housing method of claim 15, further comprising forming the air channel along an edge portion of the upper surface of the cover member.

17. The housing method of claim 15, further comprising forming the air channel along an edge portion of a lower surface of the damping plate.

18. The housing method of claim 15, further comprising restricting passage, in the air channel, of moisture and foreign materials while passing air.

19. The housing method of claim 15, further comprising forming the air channel with a zigzag form.

20. The housing method of claim 15, wherein the connecting of the air-gap further comprises equalizing pressure between the air-gap and a pressure outside the air gap.
